(19) United States
(12) Patent Application Publication
(10) Pub. No.: US 2012/0121123 A1
(43) Pub. Date: May 17, 2012

(54) INTERACTIVE DEVICE AND METHOD THEREOF

(76) Inventors: Chang-Tai HSIEH, Banciao City (TW); Li-Chen Fu, Taipei City (TW); Yu-Sheng Chen, Sanchong City (TW); Ping-Sheng Hsu, Pitou Township (TW); Che-Min Chung, Alian Township (TW)

(21) Appl. No.: 12/971,905

(22) Filed: Dec. 17, 2010

(30) Foreign Application Priority Data
Nov. 11, 2010 (TW) 099138788

(51) Int. Cl. G06K 9/00

(52) U.S. Cl. 382/103

(57) ABSTRACT

An interactive device is provided. The interactive device has a display device; a camera, for continuously filming a plurality of images in front of the display device, wherein the plurality of images includes at least one first object; and a processor, connected to the display device and the camera, for receiving the plurality of images, displaying the plurality of images on the display device, determining occurrence of an interactive movement of the first object in the plurality of images, designating an interactive object in the plurality of images when the interactive movement is detected, analyzing at least one characteristic of the interactive object, and controlling displayed images on the display device according to a trace of the interactive object.

### CROSS REFERENCE TO RELATED APPLICATIONS

This Application claims priority of Taiwan Patent Application No. 099138788, filed on Nov. 11, 2010, the entirety of which is incorporated by reference herein.

### BACKGROUND OF THE INVENTION

1. Field of the Invention

The present invention relates to an interactive device and in particular relates to an interactive device which is capable of identifying the speed of moving objects in images to determine whether to activate an interactive object, and control displayed images of a display device.

2. Description of the Related Art

Digital interactive billboards, screens or televisions developed in recent years allow users to use gestures to control the displayed images thereof Currently, digital interaction systems usually use image-based object detection and tracking systems to find an interactive object and process interactions between users and interactive devices according to the detection result of the interactive object as input commands. However, because such interactive systems are easily affected by complex background settings, the identification rate for interactive objects is not good, and it results in the incapability to track interactive objects effectively in an open space.

In order to solve the problem of low identification rate of interactive objects, image-based object detecting and tracking systems used by conventional digital interaction systems usually build a model of the interactive object for matching, or uses some supplementary tools (e.g. gloves) with specific identification effects (e.g. shape, color) to track the interactive object easily and increase identification rate. However, a user of the system can not choose the interactive object at will, and is restricted to the specific supplementary tools (e.g. gloves), which is inconvenient for users.

For example, an interactive billboard in Taiwan Patent No. I1274296 uses image identification technology. When a user wants to interact with a billboard through a bi-directional setting, the interactive billboard has to set the interactive object for detecting and tracking in advance. Such interactive mechanisms for pre-determining an interactive object is not appropriate for interactive billboards placed at a road side, because a passerby will not have the pre-determined interactive object. Also, because users normally forget to place interactive objects back where there came from, interactive objects placed at interactive billboards, often go missing, resulting in the lack of use of the interactive billboard.

As for the interactive system in Taiwan Patent No. 466483, background images have to be built first. However, in an open space, background images dynamically vary and can not be built in advance. Thus, the interactive systems are easily affected by different lightings, complicated backgrounds and shadows.

In view of this, an interactive device is needed to overcome the aforementioned issues. In detail, an interactive device is needed which is capable of allowing image-based object detecting and tracking systems, using current hardware specification, to find an arbitrary object of a user as an interactive object with minimum operations, to perform interaction without pre-built interactive object models and supplementary tools. Also, the interactive device should effectively track the arbitrary objects of the user and have good identification rate in an open space or with complex backgrounds.

### BRIEF SUMMARY OF THE INVENTION

Embodiments of an interactive device according to the invention are provided. The interactive device comprises a display device; a camera, for continuously filming a plurality of images in front of the display device, wherein the plurality of images includes at least one first object; and a processor connected to the display device and the camera, for receiving the plurality of images, displaying the plurality of images on the display device, determining if there is occurrence of an interactive movement of the first object in the plurality of images, designating an interactive object in the plurality of images when the occurrence of the interactive movement is determined, analyzing at least one characteristic of the interactive object, tracking a trace of the interactive object in the plurality of images according to the characteristic, and controlling displayed images on the display device according to the trace of the interactive object.

Embodiments of an interactive method according to the invention are provided. The interactive method, uses a camera to continuously film a plurality of images in front of a display device, wherein the plurality of images includes at least one first object, includes the steps of: receiving the plurality of images and displaying the plurality of images on the display device; determining if there is occurrence of an interactive movement of the first object and designating an interactive object in the plurality of images when the occurrence of the interactive movement is determined; analyzing at least one characteristic of the interactive object and tracking a trace of the interactive object in the plurality of images according to the characteristic; and controlling displayed images on the display device according to the trace of the interactive object.

Embodiments of a computer program product according to the invention are provided. The computer program product for being loaded into a machine to execute an interactive method to continuously film a plurality of images in front of a display device by a camera, wherein the plurality of images includes at least one first object, comprises: a first program code, for receiving the plurality of images and displaying the plurality of images on the display device; a second program code, for determining if there is occurrence of an interactive movement of the first object in the plurality of images and designating an interactive object in the plurality of images when the occurrence of the interactive movement is determined; a third program code, for analyzing at least one characteristic of the interactive object and tracking a trace of the interactive object in the plurality of images according to the characteristic; and a fourth program code, for controlling displayed images on the display device according to the trace of the interactive object.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates the block diagram of an interactive device according to an embodiment of the invention;

FIG. 2 illustrates the flowchart of the interactive method according to an embodiment of the invention;

FIG. 3 illustrates the flowchart of the interactive method according to another embodiment of the invention;

FIG. 4A to 4C illustrate the images in front of the display device from the camera according to an embodiment of the invention; and

FIG. 5 illustrates the flowchart of the tracking interactive process according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

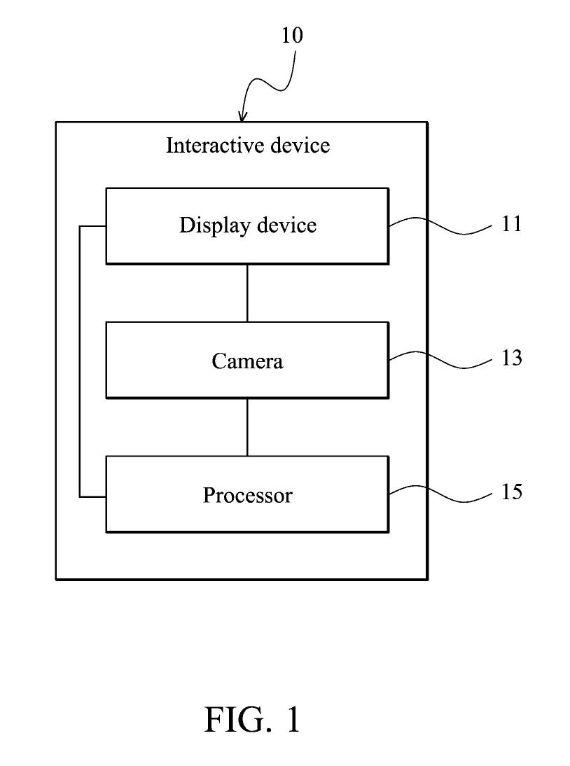

FIG. 1 illustrates the block diagram of an interactive device according to an embodiment of the invention. The interactive device 10 comprises a display device 11, a camera 13 and a processor 15, whereon the display device 11 is for displaying images, the camera 13 is for continuously filming a plurality of images in front of the display device 11 and the plurality of images includes at least one first object. The processor 15 determines if there is occurrence of an interactive movement of the first object in the plurality of images from the camera 13. If occurrence is determined, the processor 15 designates an interactive object in the plurality of images, analyzes at least one characteristic of the interactive object, tracks a trace of the interactive object in the plurality of images according to the characteristic of the interactive object, and controls the displayed images on the display device 11 according to the trace of the interactive object. In an embodiment of the invention, the first object can be arbitrary objects, such as a human body or a part of the human body (e.g. a hand). The interactive object can be one of the first object(s) or objects other than the first object. For example, when an interactive movement is detected, a second object can be placed in front of the camera to be added to the plurality of images and the second object can be designated as the interactive object.

In some embodiments of the invention, the processor 15 receives the plurality of images from the camera 13, sets and distributes a pre-determined amount of first light particles on the first object in the plurality of images, and detects moving speed of the first light particles. According to the detected moving speed of the first light particles, when the moving speed of parts of the first light particles, which are regarded as second light particles, is greater than the average moving speed of the first light particles, an interactive movement is determined by the processor 15. When the moving speed of the second light particles is greater than the moving speed of the first light particles, it indicates that the moving speed of the second light particles is a pre-determined multiple of the average moving speed of the first light particles, such as multiples between 2 to 5. The moving speed of the second light particles may also be greater than a predetermined value (a threshold value, e.g. A m/sec) of the average moving speed of the first light particles.

In another embodiment, the processor 15 can automatically determine that an object is an initial interactive object corresponding to the second light particles, which can be one of the first objects or a part of the first object. The processor 15 further displays a confirmation window on the display device 11 at a fixed position, an unspecified position or a position around the initial interactive object. When the images of a second object are inside the confirmation window, the processor 15 can determine that the second object is an interactive object interacting with the interactive device 10. In another embodiment, the second object can be one of the first object(s), a part of the first object, or objects other than the first object. The processor 15 can further analyze at least one characteristic of the interactive object, and use particle filter tracking technology to track the trace of the interactive object in the plurality of images. In some embodiments, the characteristics of the interactive object can be color, saturation, edges, and textures of the interactive object, but the invention is not limited thereto.

In some embodiments, the processor 15 can further determine whether to continuously track the trace of the interactive object. If so, the processor 15 can continue tracking the interactive object. If not so, the processor 15 re-determines that if there is another occurrence of the interactive movement of the first object in the plurality of images. When the processor 15 detects an interactive movement, the processor 15 again displays the confirmation window on the display device 11. When images of a third object are inside the confirmation window, the processor 15 can further designate the third object as the interactive object and analyze characteristics of the third object. That is, when the processor 15 is not able to keep tracking the trace of the interactive object, the processor 15 can enter a process to receive the plurality of images again, determine if there is occurrence of the interactive movement, and display the confirmation window. The images of the second object or the third object other than the second object can be displayed in the confirmation window.

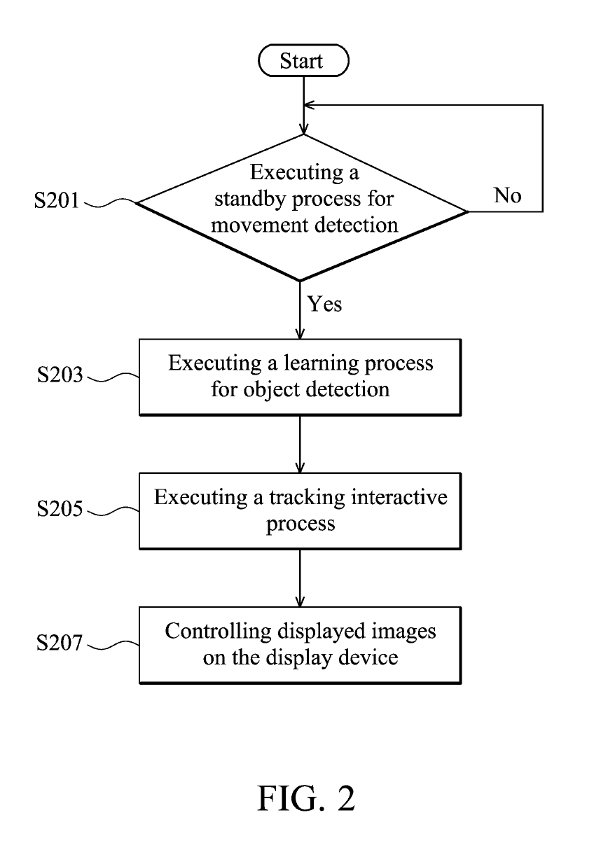

FIG. 2 illustrates the flowchart of the interactive method according to an embodiment of the invention.

In step S201, the processor 15 executes a standby process for movement detection by continuously filming a plurality of images in front of the display device 11 by the camera 13, wherein the plurality of images includes at least one first object. The processor 15 receives the plurality of images, displays the plurality of images on the display device 11, and determines occurrence of an interactive movement of the first object in the plurality of images. If an interactive movement is detected, the step S203 is executed. Otherwise, the standby process for movement detection in S201 is executed. The standby process for movement detection can be executed once every 1 to 200 ms. In a preferred embodiment, the standby process for movement detection can be executed once every 5 to 20 ms according to the performance of the processor 15, but the invention is not limited thereto.

In step S203, a learning process for object detection is executed. The learning process for object detection indicates determining if there is occurrence of an interactive object in the plurality of images and designating an interactive object in the plurality of images when the occurrence of interactive movement is determined.

In step S205, a tracking interactive process is executed. The tracking interactive process indicates analyzing at least one characteristic of the interactive object in the plurality of images, and tracking a trace of the interactive object in the plurality of images from the camera 13 according to the characteristics of the interactive object.

In step S207, the processor 15 controls the displayed images on the display device 11 according to the tracked trace of the interactive object in step S205.

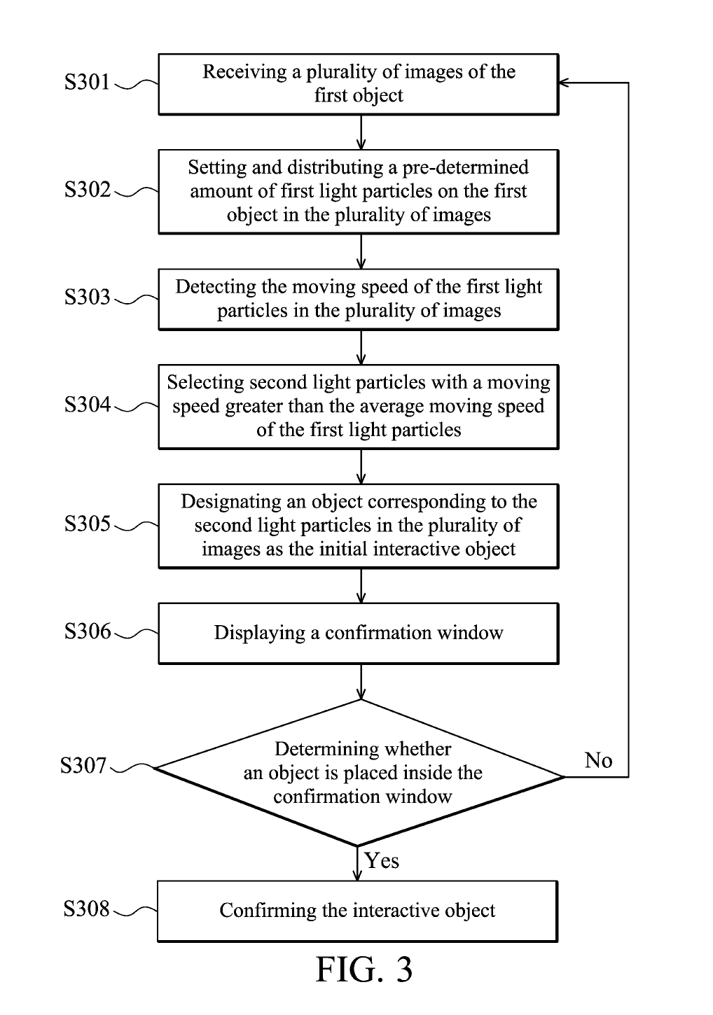

FIG. 3 illustrates the flowchart of the interactive method according to another embodiment of the invention.

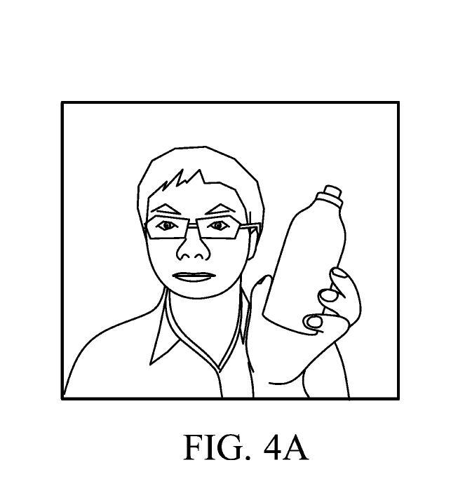

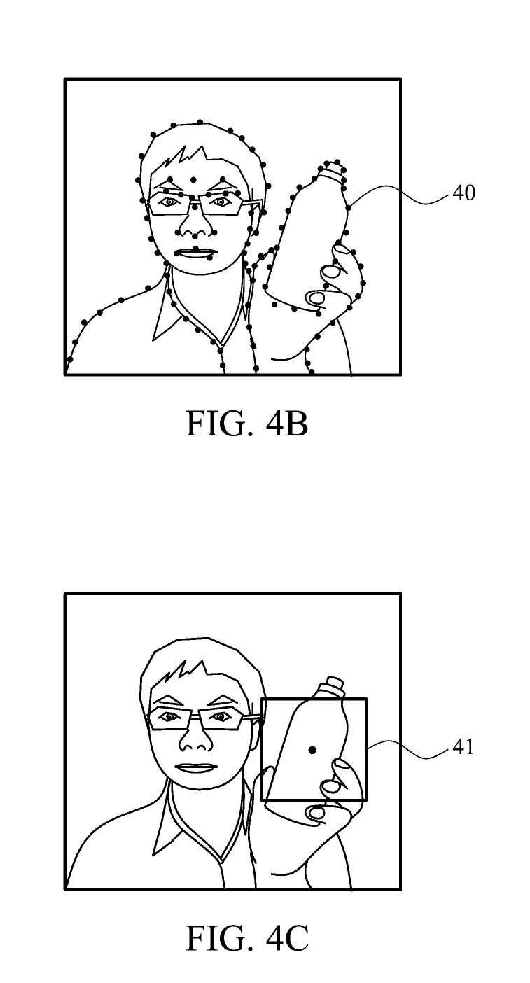

In step S301, the processor 15 receives the plurality of images in front of the display device 11 from the camera 13, wherein the plurality of images includes at least one first object. Then, the processor 15 determines that there is the occurrence of an interactive movement of the first object according to the plurality of images. For example, FIG. 4 illustrates an image of the plurality of images in front of the display device 11 from the camera 13. The camera 13 films a user holding an object in front of the display device 11. In an embodiment of the invention, for explanation, the first object is limited to the user and the object held, but the invention is not limited thereto. All human beings and objects can be regarded as the first object in the plurality of images.

In step S302, the processor 15 sets and distributes a pre-determined amount of first light particles on the first object in the plurality of images. As the light particles illustrate in FIG. 4B, the first objects in the plurality of images in step S301 is set and distributed with a pre-determined amount of first light particles, wherein the method to set light particles, such as a particle filter method, can be implemented with prior works, such as that of “A tutorial on particle filters for online nonlinear/non-Gaussian Bayesian tracking” by Arulampalam et al. in IEEE Transactions on Signal Processing, February 2002 and the document “ICONDENSATION: Unifying Low-Level and High-Level Tracking in a Stochastic Framework” by Isard and Andrew Blake.

In step S303, the processor 15 detects the moving speed of the first light particles in the plurality of images.

In step S304, the processor 15 determines occurrence of an interactive movement according to the detected moving speed of first light particles when the moving speed of second light particles of the first light particles is greater than the average moving speed of the first light particles, in which the second light particles are parts of the first light particles. In some embodiments, when the moving speed of the second light particles is greater than the moving speed of the first light particles, it indicates that the moving speed of the second light particles is a pre-determined multiple of the average moving speed of the first light particles, for example a multiple of 2 or multiples 3 to 5, which are preferred in the embodiments. The moving speed of the second light particles may also be greater than a predetermined value, which is the average moving speed of the first light particles. The pre-determined multiple or pre-determined value can be decided according to actual practice or testing, but the invention is not limited thereto. In the step, a fast stream of light particles is used to activate an interactive movement. Because the dynamic conditions are adapted for determination, the light particles can also be used in a scene with a complex background or a simple background and the parameters need not to be set again according to different places where the interactive devices are placed in.

In step S305, the processor 15 designates an object as an initial interactive object corresponding to the second light particles. For example, in the plurality of images as illustrated in FIGS. 4A and 4B, when the user is waving the object held on his hand, the processor will set the light particles on the object with motion. As step S304, when an interactive movement is detected, a relatively fast moving object corresponding to the light particles can be found. That is, the object held by the user is designated as the initial interactive object.

In step S306, the processor 15 displays a confirmation window on the display device 11. In one embodiment, the user can place the initial interactive object or other object as the interactive object to make the images of the object are inside the confirmation window in the plurality of images. In another embodiment, the initial interactive object can be automatically designated as the interactive object. The confirmation window can be placed in a fixed position, an unspecified position, or a position around the initial interactive object on the display device 11. As illustrated in FIG. 4C according to an embodiment of the invention, the confirmation window 41 is displayed around the image of the initial interactive object on the display device 11.

In step S307, when images of a second object are inside the confirmation window, the processor 15 designates the second object as the interactive object. In one embodiment, when the images of the initial interactive object are inside the confirmation window for a pre-determined time interval (e.g. several seconds), the processor 15 determines that the initial interactive object is actually the interactive object for interaction. In another embodiment, if the user places another bottle to make the image of the bottle is inside the confirmation window, the processor 15 will analyze the images of the bottle and designate the bottle as the interactive object (step S308). If there is no image of any object inside the confirmation window, the standby process for searching for a new interactive object in step S301 is executed.

In step S308, the processor 15 analyzes at least one characteristic of the images of the interactive object whose images are inside the confirmation window.

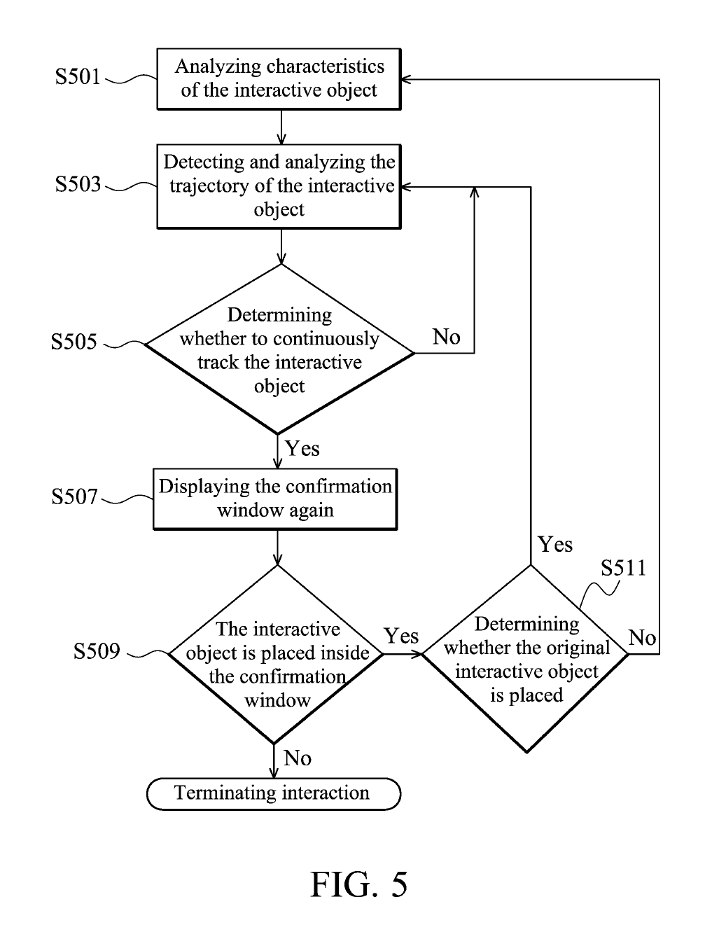

FIG. 5 illustrates the flowchart of the tracking interactive process according to an embodiment of the invention.

In step S501, the processor 15 analyzes the characteristics of the interactive object which can be set according to practical conditions. For example, the characteristics can be color, saturation, edges, and textures of the interactive object.

In step S503, the processor 15 determines whether to continuously track the trace of the interactive object. For example, particle filter tracking technology is used for stably track the trace of the interactive object. A method of repeated sampling of important characteristics can be used to deduce unnecessary operations and increase the quality of tracking. Also, a dividing sampling method can be adapted to retrieve information of interactive positions by tracking, and performing rotation and scaling matching can be used to reduce the complexity of operations according to the information of interactive positions.

In step S505, the processor 15 determines whether to continuously track the interactive object. If so, step S503 is executed. Otherwise, if the processor 15 can not track the interactive object, step S507 is executed.

In step S507, the processor 15 re-displays the confirmation window on the display device 11. In one embodiment, when the confirmation window appears again, the user can change or alternate the interactive object for interaction by simply placing the object to make the images of the object are inside the confirmation window in the plurality of images.

In step S509, the processor 15 determines whether images of an interactive object are inside the confirmation window, wherein the interactive object can be the second object or a third object. If an image of an object is inside the confirmation window, step S511 is executed. If no image of any object is inside the confirmation window, the interactive device terminates the interactive process and goes back to the standby process for movement detection.

In step S511, the processor 15 determines whether the image of the object inside the confirmation window is the original interactive object. If so, step S503 is executed to continue tracking and analyzing the trace of the interactive object without analyzing the characteristics of the interactive object. Otherwise, step S501 is executed to re-analyze the characteristics of the interactive object.

According to the aforementioned method, when an interactive movement is detected, the processor 15 can provide a confirmation window to wait for the user to place the interactive object for interaction therein. The processor will analyze the characteristics of the interactive object whose image is inside the confirmation window. Thus, the interactive method of the invention can use common objects as an interactive object and does not need to preset the types and styles of the interactive object. The user can select a nearby object as the interactive object to interactive with the interactive device 10, such as control the displayed images on the display device.

In addition, according to the aforementioned method, if the trace of the interactive object is covered or the user moves the interactive object out of the range of the camera 13 by mistake, the confirmation window will re-appear for the user to place the original interactive object to make the image of the original interactive object is inside the confirmation window for interaction without analyzing the original interactive object again.

The invention can also be implemented by a computer program product which is loaded into a machine to execute an interactive method to continuously film a plurality of images in front of a display device by a camera, wherein the plurality of images includes at least one first object, comprising: a first program code, for receiving the plurality of images and displaying the plurality of images on the display device; a second program code, for determining if there is occurrence of an interactive movement of the first object in the plurality of images and designating an interactive object in the plurality of images when the the occurrence of interactive movement is determined; a third program code, for analyzing at least one characteristic of the interactive object and tracking a trace of the interactive object in the plurality of images according to the characteristic; and a fourth program code, for controlling displayed images on the display device according to the trace of the interactive object.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An interactive device, comprising:
a display device;
a camera, for continuously filming a plurality of images in front of the display device, wherein the plurality of images includes at least one first object; and
a processor, connected to the display device and the camera, for receiving the plurality of images, displaying the plurality of images on the display device, determining if there is occurrence of an interactive movement of the first object in the plurality of images, designating an interactive object in the plurality of images when the occurrence of the interactive movement is determined, analyzing at least one characteristic of the interactive object, tracking a trace of the interactive object in the plurality of images according to the characteristic, and controlling displayed images on the display device according to the trace of the interactive object.

2. The interactive device as claimed in claim 1, wherein the processor further sets and distributes a pre-determined amount of first light particles on the first object in the plurality of images, detects moving speed of the first light particles, and determines that there is the occurrence of the interactive movement according to the detected moving speed of the first light particles and when the moving speed of second light particles is greater than average moving speed of the first light particles, in which the second light particles are parts of the first light particles.

3. The interactive device as claimed in claim 2, wherein when the moving speed of the second light particles is greater than the average moving speed of the first light particles, the moving speed of the second light particles is a pre-determined multiple of the average moving speed of the first light particles, or a pre-determined value greater than the average moving speed of the first light particles.

4. The interactive device as claimed in claim 1, wherein the processor further displays a confirmation window on the display device when the interactive movement is detected, and designates a second object as the interactive object and analyzes at least one characteristic of the second object when images of the second object are inside the confirmation window in the plurality of images.

5. The interactive device as claimed in claim 4, wherein the processor uses particle filter tracking technology to track the trace of the interactive object in the plurality of images.

6. The interactive device as claimed in claim 1, wherein the characteristics of the interactive objects comprise color, saturation, edges and textures of the interactive object.

7. The interactive device as claimed in claim 4, wherein the processor further determines whether to continuously track the trace of the interactive object, and
if so, the processor keeps to track the interactive object, and
if not so, the processor re-determines that if there is another occurrence of interactive movement of any first object in the plurality of the images.

8. The interactive device as claimed in claim 7, wherein the processor further displays the confirmation window on the display device when the interactive movement is detected by the processor, and the processor further designates a third object as the interactive object and analyzes at least one characteristic of the third object when images of the third object are inside the confirmation window in the plurality of images.

9. An interactive method executed by an interactive device, which uses a camera to continuously film a plurality of images in front of a display device, wherein a plurality of images includes at least one first object, comprising the steps of:
receiving the plurality of images and displaying the plurality of images on the display device;
determining if there is occurrence of an interactive movement of the first object and designating an interactive object in the plurality of images when the occurrence of the interactive movement is determined;
analyzing at least one characteristic of the interactive object and tracking a trace of the interactive object in the plurality of images according to the characteristic; and
controlling displayed images on the display device according to the trace of the interactive object.

10. The interactive method as claimed in claim 9, further comprising:
setting and distributing a pre-determined amount of first light particles on the first object in the plurality of images;
detecting moving speed of the first light particles; and
determining that there is the occurrence of the interactive movement according to the detected moving speed of the first light particles and when moving speed of second light particles of the first light particles is greater than average moving speed of the first light particles, wherein the second light particles are parts of the first light particles.

11. The interactive method as claimed in claim 10, wherein when the moving speed of the second light particles is greater than the average moving speed of the first light particles, the moving speed of the second light particles is a pre-determined multiple of the average moving speed of the first light particles, or a pre-determined value greater than the average moving speed of the first light particles.

12. The interactive method as claimed in claim 9, wherein when the interactive movement is detected, the steps further comprise:
displaying a confirmation window on the display device; and
designating a second object as the interactive object and analyzing at least one characteristic of the second object when images of the second object are inside the confirmation window in the plurality of images.

13. The interactive method as claimed in claim 12, wherein the trace of the interactive object in the plurality of images is tracked by using particle filter tracking technology.

14. The interactive method as claimed in claim 9, wherein the characteristics of the interactive object comprise color, saturation, edges and textures of the interactive object.

15. The interactive method as claimed in claim 12, wherein the steps further comprise:
determining whether to continuously track the trace of the interactive object; and
if so, keeping to track the interactive object, and
if not so, re-determining that if there is another occurrence of interactive movement of any first object in the plurality of images.

16. The interactive method as claimed in claim 15, wherein the steps further comprise:
displaying the confirmation window on the display device when the interactive movement is again detected; and
designating a third object as the interactive object and analyzing at least one characteristic of the third object when images of the third object are inside the confirmation window in the plurality of images.

17. A computer program product which is loaded by a machine to execute an interactive method to continuously film a plurality of images in front of a display device by a camera, wherein the plurality of images includes at least one first object, comprising:
a first program code, for receiving the plurality of images and displaying the plurality of images on the display device;
a second program code, for determining if there is occurrence of an interactive movement of the first object in the plurality of images and designating an interactive object in the plurality of images when the occurrence of the interactive movement is determined;
a third program code, for analyzing at least one characteristic of the interactive object and tracking a trace of the interactive object in the plurality of images according to the characteristic; and
a fourth program code, for controlling displayed images on the display device according to the trace of the interactive object.
